(19) United States
(12) Patent Application Publication
(10) Pub. No.: US 2014/0209235 A1
(43) Pub. Date: Jul. 31, 2014

(54) METHOD FOR LAYING CARBON NANTOUBE FILM ON A SUPPORT FILM

(71) Applicant: Beijing FUNATE Innovation Technology Co., LTD., Beijing (CN)

(72) Inventors: LI QIAN, Beijing (CN); YU-QUAN WANG, Beijing (CN)

(21) Appl. No.: 13/928,362

(22) Filed: Jun. 26, 2013

(30) Foreign Application Priority Data
Jan. 30, 2013 (CN) 2013100354181

(51) Int. Cl. B32B 37/00

(52) U.S. Cl. CPC B32B 37/0038
USPC 156/242

(57) ABSTRACT

A method includes the following steps. A carbon nanotube array is provided. An original carbon nanotube film is drawn from the carbon nanotube array and suspended. The original carbon nanotube film includes a plurality of carbon nanotubes substantially oriented along a first direction. The suspended original carbon nanotube film is soaked with an atomized organic solvent to form a carbon nanotube film. A support film is provided. The carbon nanotube film is attached to the support film. Wherein, the atomized organic solvent comprises a plurality of organic droplets separated from each other with diameters of larger than or equal to 10 micrometers, and less than or equal to 100 micrometers.

### RELATED APPLICATIONS

This application claims all benefits accruing under 35 U.S.C. §119 from China Patent Application No. 201310035418.1, filed on Jan. 30, 2013 in the China Intellectual Property Office, the disclosure of which is incorporated herein by reference.

### BACKGROUND

1. Technical Field

The present disclosure relates to a method for laying a carbon nanotube film on a support film.

2. Discussion of Related Art

A carbon nanotube film can be continuously formed by drawing from a carbon nanotube array. The carbon nanotube film is a macroscopic structure, and includes a plurality of carbon nanotubes joined end-to-end by van der Waals force. Some of the carbon nanotubes in the carbon nanotube film are spaced from each other, so the carbon nanotube film allows light to be transmitted. In addition, the carbon nanotubes are substantially oriented along a same direction, thus the carbon nanotube film has excellent various properties, such conductive electricity and heat along axial direction of the carbon nanotubes. The carbon nanotube film can be widely used.

The carbon nanotube film keeps itself shape by van der Waals force between the carbon nanotubes in the carbon nanotube film. The carbon nanotube film is thin and easily broken. Therefore, the carbon nanotube film is often used by adhering to a support. However, the carbon nanotube film is black or grey, which makes the carbon nanotube film not transparent. Thus, the carbon nanotube film isn't conducive to be used as a transparent conductive element.

What is needed, therefore, is to provide a method for laying a carbon nanotube film on a support film that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flow chart of one embodiment of a method for laying a carbon nanotube film on a support film.

FIG. 2 is a method process view of the method shown in FIG. 1.

FIG. 3 is a scanning electronic microscopic image of an original carbon nanotube film used in FIG. 1.

FIG. 4 is a photograph of the original carbon nanotube film shown in FIG. 3.

FIG. 5 is a photograph of the carbon nanotube film made by FIG. 1.

FIG. 6 is a method process view of one embodiment of a method for laying a carbon nanotube film on a support film.

FIG. 7 is a method process view of one embodiment of a method for laying a carbon nanotube film on a support film.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

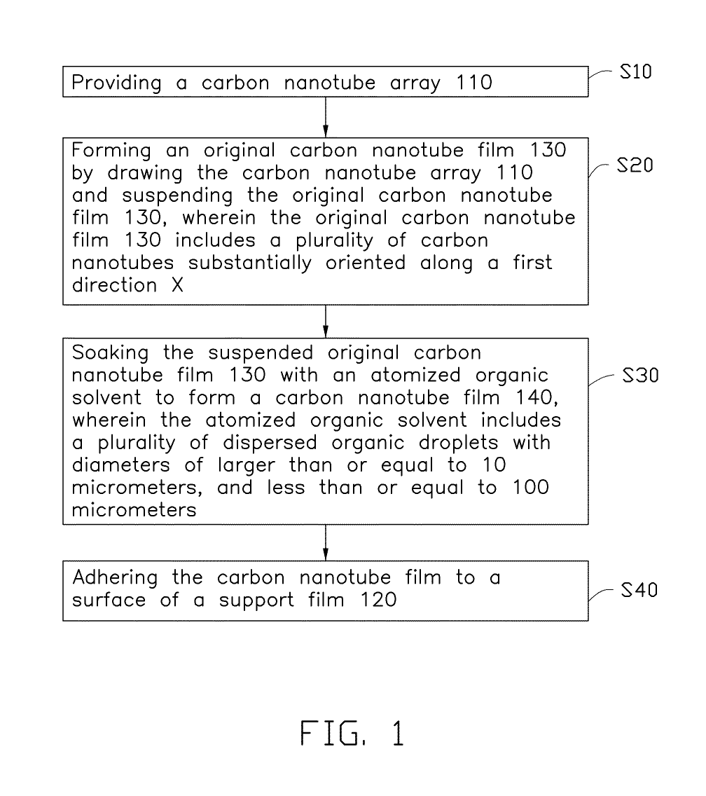

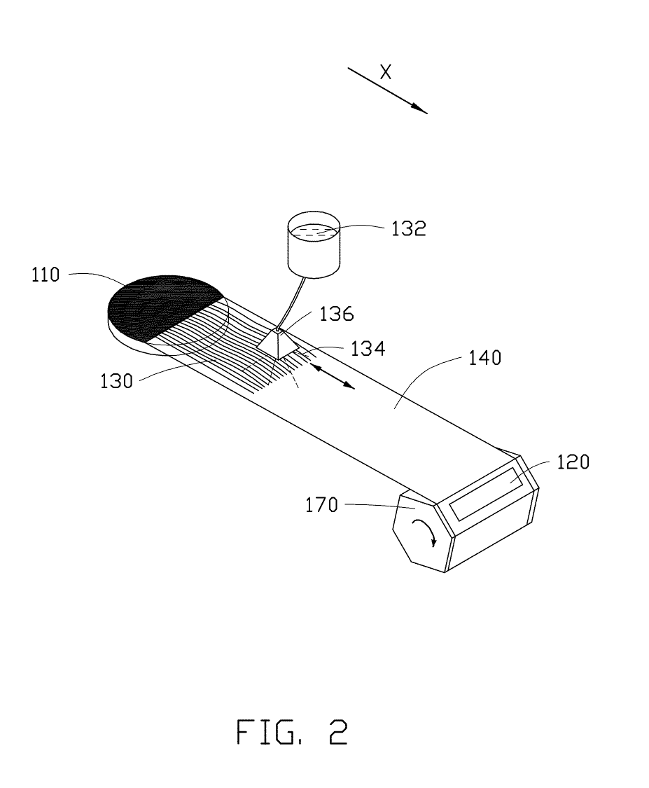

Referring to FIGS. 1 and 2, one embodiment of a method for laying a carbon nanotube film on a support film is provided. The method includes the following steps:

S10, providing a carbon nanotube array 110;

S20, forming an original carbon nanotube film 130 by drawing the carbon nanotube array 110 and suspending the original carbon nanotube film 130, wherein the original carbon nanotube film 130 includes a plurality of carbon nanotubes substantially oriented along a first direction X;

S30, soaking the suspended original carbon nanotube film 130 with an atomized organic solvent to form a carbon nanotube film 140, wherein the atomized organic solvent includes a plurality of dispersed organic droplets with diameters of larger than or equal to 10 micrometers, and less than or equal to 100 micrometers; and

S40, adhering the carbon nanotube film to a surface of a support film 120.

In step S10, the carbon nanotube array 110 can be a single-walled carbon nanotube array, a double-walled carbon nanotube array, a multi-walled carbon nanotube array, or any combination thereof. In one embodiment, the carbon nanotube array 110 is a multi-walled carbon nanotube array. The carbon nanotube array 110 is essentially free of impurities, such as carbonaceous or residual catalyst particles. The carbon nanotube array 110 can be a super aligned carbon nanotube array including a plurality of carbon nanotubes substantially parallel to each other. A method for making the carbon nanotube array 110 is unrestricted, and can be by chemical vapor deposition methods or other methods.

Step S20 includes steps of:

(a) selecting a number of carbon nanotube segments with a certain width from the carbon nanotube array 110 using a drawing tool; and

(b) pulling the carbon nanotube segments at a uniform speed along the first direction X to form the continuously original carbon nanotube film 130.

The drawing tool having a certain width can be a tape, a tweezers, or a clamp. In one embodiment, the first direction X is substantially perpendicular to a growing direction of the carbon nanotube array 110. The carbon nanotubes in the original carbon nanotube film 130 are substantially oriented along the first direction X.

During the pulling process, as the initial carbon nanotube segments are drawn out, other carbon nanotube segments are also drawn out end to end due to van der Waals force between ends of adjacent segments. This process of pulling produces a substantially continuous and uniform original carbon nanotube film 130 having a predetermined width. During the pulling process, one end of the original carbon nanotube film 130 is connected to the carbon nanotube array 110 by van der Waals force, and the other end is connected to the drawing tool. As such, the original carbon nanotube film 130 is continuously formed. The method for making the original carbon nanotube film 130 is easy and can be applied in industry.

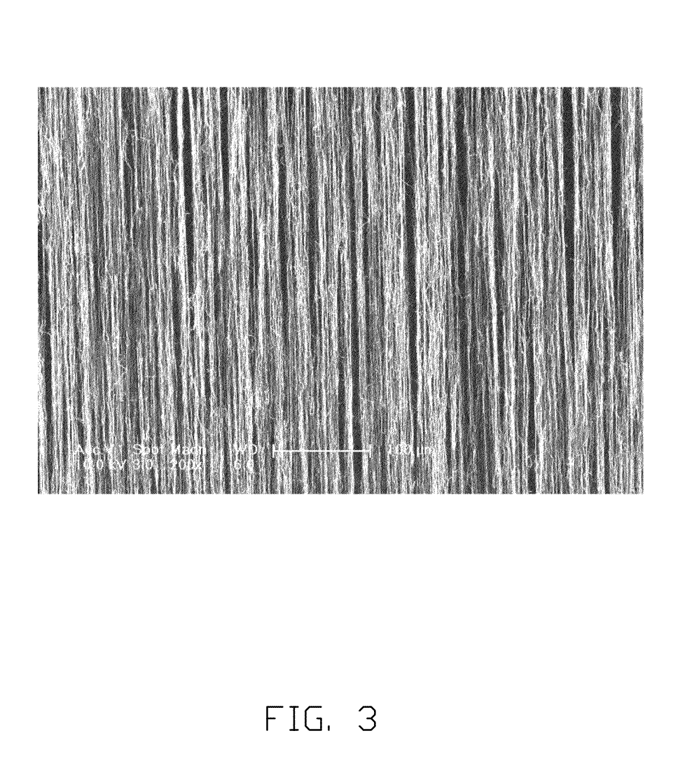

The original carbon nanotube film 130 can be a free-standing structure substantially consisting of a plurality of carbon nanotubes. The term “free-standing structure” includes but is not limited meaning the original carbon nanotube film 130 can keep its film-shape without any support. Referring to FIG. 3, most of the carbon nanotubes in the original carbon nanotube film 130 substantially extend along a same direction. Axial extending directions of the most carbon nanotubes are substantially parallel to a surface of the original carbon nanotube film 130. Furthermore, the original carbon nanotube film 130 includes a plurality of substantially parallel carbon nanotubes and carbon nanotubes joined end-to-end by van der Waals force. Specifically, each carbon nanotube of the most carbon nanotubes and adjacent carbon nanotube on the same extending direction are joined end-to-end by van der Waals force. Understandably, a few carbon nanotubes in the original carbon nanotube film are not oriented along the extending directions of the most carbon nanotubes, which does not obviously affect the whole preferred orientation of the most carbon nanotubes in the original carbon nanotube film 130.

The step S20 can be a step of providing a plurality of carbon nanotube arrays 110. The plurality of carbon nanotube arrays 110 can be drawn out to form a plurality of original carbon nanotube films 130 at the same time. In addition, a plurality of original carbon nanotube films 130 also can be formed from a same carbon nanotube array 110.

The step S30 is mainly to soak the suspended original carbon nanotube film 130 using the atomized organic solvent for at least one time. The atomized organic solvent can be reserved before the step S30. In one embodiment, the atomized organic solvent is prepared during the process of the step S30, as such the step S30 can include steps of: providing a volatilizable organic solvent 132; atomizing the organic solvent 132 into a plurality of dispersed organic droplets 134; and spraying the organic droplets 134 onto the surface of the suspended original carbon nanotube film 130 and the organic droplets 134 gradually penetrating onto the carbon nanotubes of the original carbon nanotube film 130, thereby making the suspended original carbon nanotube film 130 be soaked at least one time by the organic droplets 134, and then make the original carbon nanotube film 130 shrink into the carbon nanotube film 140. The organic droplets 134 are tiny organic solvent drops suspended in surrounding. The organic solvent 132 can be atomized into the organic droplets 134 by ultrasonic atomization method, high pressure atomizing method or other methods.

The organic solvent 132 can be alcohol, methanol, acetone, acetic acid, and other volatilizable solvent. During the spraying process, a pressure is produced, when the organic droplets 134 are sprayed, the pressure is small and cannot break the original carbon nanotube film 130. The diameter of each organic droplet 134 is larger than or equal to 10 micrometers, or less than or equal to 100 micrometers, such as about 20 micrometers, 50 micrometers. Thus, an interface force is produced between the original carbon nanotube film 130 and the organic droplets 134. The interface force can ensure that the original carbon nanotube film 130 is shrunk and the carbon nanotubes in the original carbon nanotube film 130 are dispersed more uniformly, thereby forming the carbon nanotube film 140.

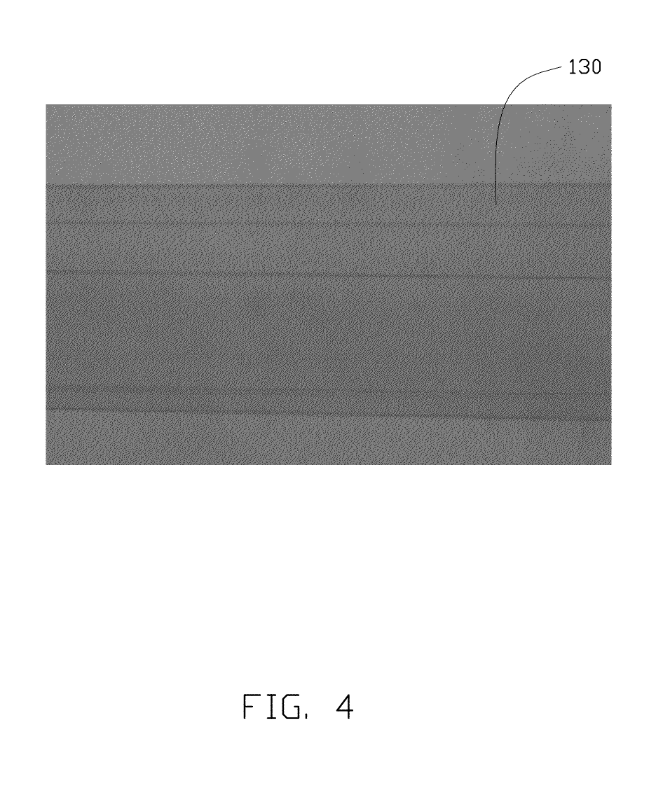

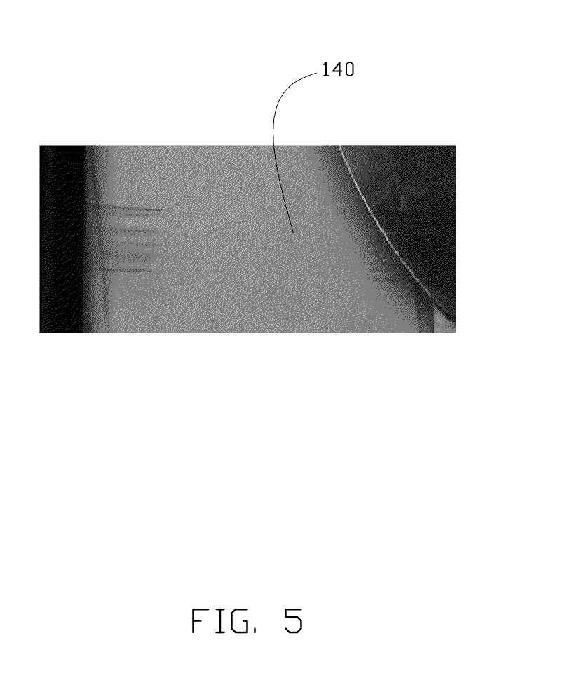

The organic solvent 132 is volatile and easy to be volatilized. When the organic droplets 134 are sprayed onto the original carbon nanotube film 130 and then penetrated into the original carbon nanotube film 130, the organic droplets 134 are volatilized, carbon nanotube segments loosely arranged in the original carbon nanotube film 130 are tightly shrunk. The diameter of each organic droplet 134 is larger than or equal to 10 micrometers, or less than or equal to 100 micrometers, the soaked scope of the carbon nanotube segment of the original carbon nanotube film 130 is limited by the small diameter of each organic droplet 134. Thus, diameters of the carbon nanotube segments of the original carbon nanotube film 130 can be shrunk into less than or equal to 10 micrometers, the carbon nanotube segments are almost invisible using naked eyes in the carbon nanotube film 140. The original carbon nanotube film 130 is black or grey as shown in FIG. 4, after the step S30, the original carbon nanotube film 130 is shrunk into the carbon nanotube film 140, and the carbon nanotube film 140 is more transparent shown in FIG. 5.

The method for making the carbon nanotube film 140 is simple, highly effective, and easy to be controlled. The method for making the carbon nanotube film 140 is environmental friendly and suitable for a large scale produce. The carbon nanotube film 140 is transparent; it can be used as a transparent element. Therefore, the carbon nanotube film 140 can be widely used in display devices, such as touch panels.

In another embodiment, the step S30 can be a step of soaking the suspended original carbon nanotube film 130 using the atomized organic solvent for many times, and the step can include sub-steps of:

S31, providing at least one spray nozzles 136 located above the original carbon nanotube film 130; and

S32, moving the at least one spray nozzles 136 or the original carbon nanotube film along the first direction X, simultaneously, atomizing the organic solvent 132 into the dispersed organic droplets 134, the organic droplets 134 being sprayed from the at least one spray nozzles 136 and fallen on the original carbon nanotube film 130, thereby the original carbon nanotube film 130 being soaked and shrunk into the carbon nanotube film 140.

When the original carbon nanotube film 130 is soaked for many times by the organic droplets 134, the at least one spray nozzle 136 can be one spray nozzle 136 moving above the original carbon nanotube film 130 along the first direction X. Specifically, the suspended original carbon nanotube film 130 is fixed, at the same time, the spray nozzle 136 is moved along a direction substantially parallel to the first direction X to and fro, and the original carbon nanotube film 130 is soaked for many times on all directions. The organic droplets 134 sprayed from the spray nozzle 136 cover the original carbon nanotube film 130 not only along the length direction of the original carbon nanotube film 130 but also along the width direction of the original carbon nanotube film 130. The at least one spray nozzle 136 can be a plurality of spray nozzles 136 arranged along a second direction intercrossed with the first direction X, and the spray nozzles 136 are moved along a direction substantially parallel to the first direction X to and fro, which makes the original carbon nanotube film 130 soaked for many times. In one embodiment, the second direction is substantially perpendicular to the first direction X.

In still another embodiment, the step S30 can also include sub-steps of: providing a plurality of spray nozzles 136 arranged above the original carbon nanotube film 130 along the first direction X; and atomizing the organic solvent 132 into the organic droplets 134, and spraying the organic droplets 134 from each of the spray nozzles 136 onto the original carbon nanotube film 130, simultaneously, moving the original carbon nanotube film 130 along the first direction X, as such the original carbon nanotube film 130 is soaked with the organic droplets 134 for many times to form the carbon nanotube film 140.

It is not limited how to perform the step S30, as long as the suspended original carbon nanotube film 130 is soaked with the organic droplets 134 on the width direction substantially perpendicular to the first direction X. In step S30, no matter one or many spray nozzles 136 are provided, the arrangement of the spray nozzle 136 should demand that the organic droplets 134 sprayed from the one or more spray nozzles 136 at least can cover the original carbon nanotube film 130 on the width direction. Therefore, the original carbon nanotube film 130 is uniformly soaked. In one embodiment, the at least one spray nozzle 136 are at least two spray nozzles 136.

In one embodiment, one spray nozzle 136 is moved along the first direction X to and fro, to soak the original carbon nanotube film 130 for two times using the organic droplets 134. Specifically, one end of the original carbon nanotube film 130 is connected to the carbon nanotube array 110, the other end is fixed at a collector 170. The original carbon nanotube film 130 is suspended between the carbon nanotube array 110 and the collector 170. The collector 170 makes the original carbon nanotube film 130 continuously be drawn from the carbon nanotube array 110 along the first direction X. The spray nozzle 136 is located above the suspended original carbon nanotube film 130. The organic solvent 132 is atomized into the organic droplets 134 by the high pressure atomizing method, the organic droplets 134 sprayed from the spray nozzle 136 are fallen down to the surface of the suspended original carbon nanotube film 130, thus the original carbon nanotube film 130 is soaked to be shrunk. As the rotating of the collector 170, the original carbon nanotube film 130 will be continuously drawn from the carbon nanotube array 110 along the first direction X, the spray nozzle 136 will move to and fro above the original carbon nanotube film 130 to soak the original carbon nanotube film 130 with the organic droplets 134 for twice. The original carbon nanotube film 130 is shrunk into the carbon nanotube film 140. In one embodiment, the organic solvent 132 is alcohol.

The original carbon nanotube film 130 is soaked with the organic droplets 134 many times. The original carbon nanotube film 130 is also shrunk many times. During the many soaking processes, the organic droplets 134 fall on different positions of the original carbon nanotube film 130, and the diameters of the organic droplets 134 falling on the same position of the original carbon nanotube film 130 are different. The interfacial forces are produced between the organic droplets 134 and the original carbon nanotube film 130 at the same position in order. The interfacial forces are also different at the same position. Therefore, the carbon nanotube segments in the original carbon nanotube film 130 at the same position will be shrunk under the different interfacial forces in order. Because the diameters of the organic droplets 134 are small, the interfacial forces will not make the carbon nanotube segments in the original carbon nanotube film 130 shrink into black linear structures. After shrinking the carbon nanotube segments, the shrunk carbon nanotube segments are intercrossed into the carbon nanotube film 140 with a uniform network structure. The network structure in the carbon nanotube film 140 can be invisible to the naked eyes. Therefore, the carbon nanotube film 140 is transparent. The carbon nanotubes in the carbon nanotube film 140 are more uniformly arranged, the tensile strength of the carbon nanotube film 140 is strong, after the original carbon nanotube film 130 is soaked and shrunk many times in order. After soaking and shrinking the original carbon nanotube film 130 many times, the carbon nanotube film 140 is strong enough to not break when wrapped around the collector 170. The carbon nanotube film 140 can be continuously produced.

The collector 170 is configured to draw the original carbon nanotube film 130 from the carbon nanotube array 110, and collect the carbon nanotube film 140.

In step S40, the carbon nanotube film 140 can be directly adhered to the support film 120 by self adhesion to form a carbon nanotube composite film structure 100. The carbon nanotube film 140 also can be adhered to the support film 120 by adhesive, thus the step S40 can include sub-steps of: forming an adhesive layer on the support film 120 by a coating method or a spraying method; and covering the carbon nanotube film 140 on the adhesive layer such that the carbon nanotube film 140 is fixed on the support film 120 by the adhesive layer.

The support film 120 is mainly configured to support the carbon nanotube film 140. A material of the support film 120 can be glass, quartz, or other hard material. The material of the support film 120 also can be a flexible material, such as polycarbonate (PC), polyethylene (PE), polypropylene (PP), polymethyl methacrylate (PMMA), polyethylene terephthalate (PET), polyether sulfone (PES), polyimide (PI), polyvinyl chloride (PVC), benzocyclobutene (BCB), cellulose ester, polyester, acrylic resin or any combination thereof. In one embodiment, a material of the support film 120 is the flexible material, and a transparence of the support film 120 is greater than 75%.

The step S40 can include sub-steps of: S41, continuously providing the support film 120 from a support film supply unit; and S42, continuously passing the support film 120 and the carbon nanotube film 140 between a pressing unit to fix the carbon nanotube film 140 on the support film 120, thereby continuously forming the carbon nanotube composite film structure 100. The carbon nanotube film 140 can be fixed on the support film 120 by a roll-to-roll procedure. The step S40 can further include a step S43: continuously collecting the carbon nanotube composite film structure 100 on a collecting unit.

In one embodiment, the support film 120 is a planar PET film, the PET film is fixed on the collector 170. As rotating of the collector 170, the carbon nanotube film 140 is continuously laid on and adhered to the support film 120 by itself adhesion, the original carbon nanotube film 130 is continuously drawn from the carbon nanotube array 110 and soaked with the organic droplets twice in order, the carbon nanotube film 140 is continuously formed and laid on the support film 120. The carbon nanotube film 140 and the carbon nanotube composite film structure 100 can be industrially produced.

When a plurality of original carbon nanotube films 130 are drawn from a plurality of carbon nanotube arrays 110 separately overlapped, ends of the original carbon nanotube films 130 away from the carbon nanotube arrays 110 are directly overlapped with each other to form a suspended original carbon nanotube film structure. The suspended original carbon nanotube film structure is soaked with the organic droplets to form the carbon nanotube film 140. Then, the carbon nanotube film 140 is adhered to the support film 120.

When a plurality of original carbon nanotube films 130 are drawn from a plurality of carbon nanotube arrays 110 juxtaposed with each other, ends of the original carbon nanotube films 130 away from the carbon nanotube arrays 110 are suspended and juxtaposed. The suspended and juxtaposed original carbon nanotube films 130 are soaked with the organic droplets to form a plurality of carbon nanotube films 140. The carbon nanotube films 140 are laid on the support film 120 side by side. The width of the carbon nanotube film 140 is not limited; the width of the carbon nanotube composite film structure 100 is also not limited.

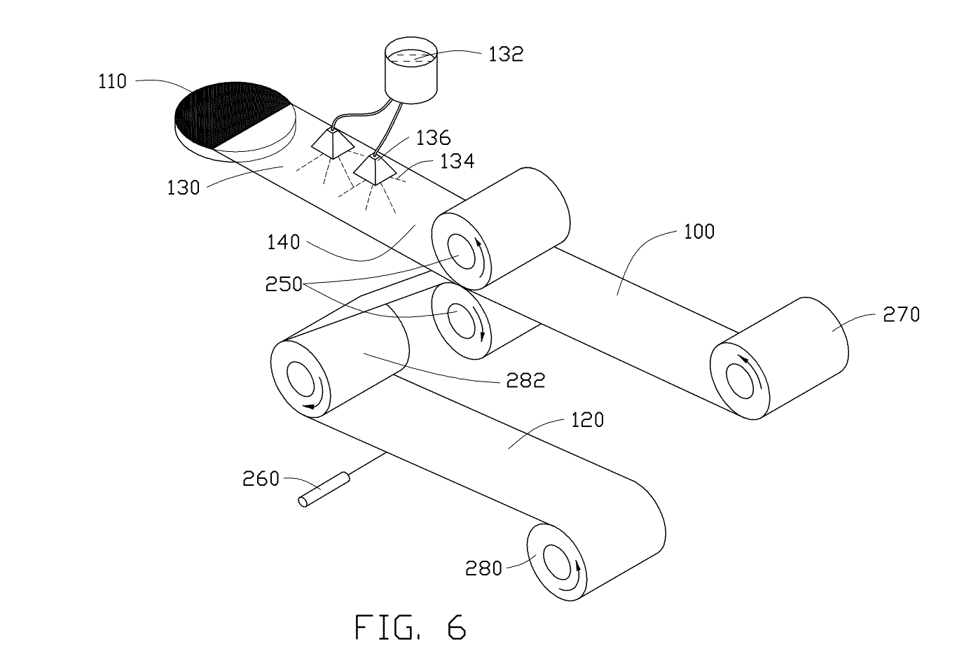

Referring to FIG. 6, one embodiment of a method for adhering the carbon nanotube film 140 to the support film 120 is provided. The method can be performed by a roll-to-roll procedure, and the method can include the following steps:

S110, providing the carbon nanotube array 110, a pair of roller 250 capable of providing a pressure, and the support film 120, and passing the support film 120 through the pair of roller 250;

S120, drawing the original carbon nanotube film 130 from the carbon nanotube array 110, wherein, one end of the original carbon nanotube film 130 is connected with the carbon nanotube array 110, the original carbon nanotube film 130 is suspended and includes a plurality of carbon nanotubes substantially oriented along the first direction X, a width of the original carbon nanotube film 130 is narrower than the width of the support film 120 and the widths of the two roller 250;

S130, soaking the suspended original carbon nanotube film 130 with an atomized organic solvent many times, to form the carbon nanotube film 140, the atomized organic solvent including a plurality of organic droplets 134 with diameters lager than or equal to 10 micrometers, and less than or equal to 100 micrometers; and

S140, passing the carbon nanotube film 140 and the support film 120 through the pair of rollers 250, simultaneously applying the pressure on carbon nanotube film 140 and the support film 120 to fix the carbon nanotube film 140 on the support film 120 such that the carbon nanotube composite film structure 100 is formed.

In the step S110, the support film 120 is provided by the support film supply unit. In one embodiment, the support film 120 is made of flexible material, the support film supply unit includes a coil 280 and the support film 120 wrapped around the coil 280. The support film supply unit can further include a flattening shaft 282, the flattening shaft 282 is configured to strain the support film 120 supplied for the rollers 250 such that the support film 120 supplied for the rollers 250 is flat and smooth, the carbon nanotube film 140 can be easily adhered to the support film 120, wrinkles can be reduced or avoided to produce during adhering the carbon nanotube film 140. The step S110 can further include a step of straining the support film 120 supplied from the coil 280 by the flattening shaft 282 before the step of passing the support film 120 through the rollers 250.

The rollers 250 are elements of a pressure unit. The pressure unit can include a control element and the pair of rollers 250. The pair of rollers 250 is rotated along opposite directions with a same speed controlled by the control element. The rollers 250 can be parallel to and contact with each other to produce the pressure for the support film 120. The rollers 250 can be rubber rollers or metal rollers. The rollers 250 can have a smooth surface. In one embodiment, the rollers 250 are capable of heating support film passed through the rollers 250 to a predetermined temperature. The rollers 250 can be wider than the support film 120.

The step S110 can further include a collecting unit 270 connecting with the support film 120 passed through the rollers 250. The collecting unit 270 is mainly configured to continuously collect the carbon nanotube composite film 100. The collecting unit 270 can be a collect shaft. In one embodiment, the collecting unit 270 is a reel. An axis of the collecting unit 270 is substantially parallel to an axis of the coil 280 and axes of the rollers 250, in order to ensure the support film 120 is smoothly passed through the rollers 250 and drawn by the collecting unit 270.

The characteristics of the step S120 is the same as that of the step S20.

The step S130 is similar to the step S30, except that the step S130 uses a plurality of spray nozzles 136 spraying the atomized organic solvent to soak the original carbon nanotube film 130 many times. In one embodiment, the other end of the original carbon nanotube film 130 away from the carbon nanotube array 110 is fixed on the support film. The original carbon nanotube film 130 between the support film 120 and the carbon nanotube array 110 is suspended. Two spray nozzles 136 are located apart from each other above the suspended original carbon nanotube film 130 along the first direction X. The pair of rollers 250 is rotated along opposite directions such that the original carbon nanotube film 130 is continuously drawn from the carbon nanotube array 110. At the same time, the organic solvent 132 is atomized into the organic droplets 134 by high pressure atomization method, and then the organic droplets 134 are sprayed out from the two spray nozzles 136 and fallen on the surface of the suspended original carbon nanotube film 130. The original carbon nanotube film 130 are soaked and shrunk two times.

In step S140, the rollers 250 and the collecting unit 270 move at the same time such that the carbon nanotube film 140 are overlapped with the support film 120. The pressure generated by the rollers 250 is applied to the overlapped carbon nanotube film 140 and the support film 120. The carbon nanotube film 140 is adhered to the support film 120 to form the carbon nanotube composite film structure 100. The carbon nanotube composite film structure 100 moves with the movement of the collecting unit 270.

Each axis of the pair of rollers 250 is substantially parallel to the surface of the carbon nanotube array 110. The original carbon nanotube film 130 and the carbon nanotube film 140 are substantially parallel to the axis of each roller 250.

The step S140 can further include steps. A UV adhesive is coated on a surface of the support film 120 to form an adhesive layer 260. Then the carbon nanotube film 140 and the support film 120 with the adhesive layer 260 thereon are passed through the rollers 250, and the carbon nanotube film 140 is contacted with the adhesive layer 260, before the adhesive layer 260 is solidified. The carbon nanotube film 140, the adhesive layer 260 and the support film 120 are pressed by the rollers 250. At least part of carbon nanotubes in the carbon nanotube film 140 is penetrated into the adhesive layer 260. Finally, the adhesive layer 260 is solidified using UV radiating such that the carbon nanotube film 140 is tightly fixed on the support film 120 by the adhesive layer 260.

In one embodiment, the rollers 150 are heated to a high temperature, the support film 120 and the carbon nanotube film 140 are hot pressed. The carbon nanotube film 140 is tightly combined with the support film 120. When the adhesive layer 260 is coated on the support film 120, the adhesive layer 260 can be melted when passing between the rollers 150, a part of carbon nanotubes in the carbon nanotube film 140 are penetrated into the adhesive layer 260.

In the step S40, the pair of rollers 250 are rotated along opposite directions, the support film 120 and the carbon nanotube film 140 are stacked with each other.

Then, the overlapped support film 120 and carbon nanotube film 140 are passed between the rollers 250. The carbon nanotube film 140 is fixed on the support film 120 by the pressure applied by the rollers 150 to form the carbon nanotube composite film structure 100. As the rotating of the rollers 250, the carbon nanotube film 140 is continuously formed, the original carbon nanotube film 130 is continuously drawn out from the carbon nanotube array 110, the original carbon nanotube film 130 is continuously soaked by the organic droplets 134 many times to form the carbon nanotube film 140. At the same time, the support film 120 is also continuously stretched from the coil 280 as the rotating of the rollers 250, and combined with the carbon nanotube film 140 by the pressure to form the carbon nanotube composite film structure 100. The collecting unit 270 and the rollers 250 are rotated with the same speed, the carbon nanotube composite film structure 100 is continuously wrapped around the collecting unit 270. The carbon nanotube film 140 is continuously laid on the support film 120. Therefore, the roll-to-roll procedure for laying the carbon nanotube film 140 on the support film 120 can be continuously produced for a large scale. The carbon nanotube composite film structure 100 can be acted as a transparent conductive element with high transparent and electrically conductive isotropic. The carbon nanotube composite film structure 100 can be widely applied in display devices, such as touch panels.

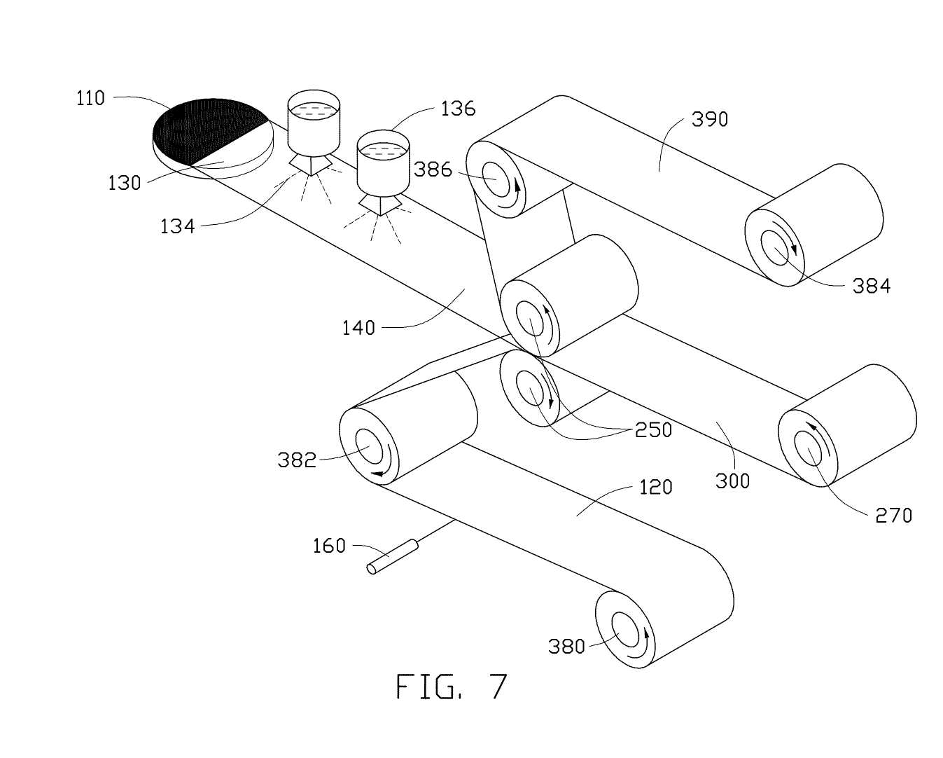

Referring to FIG. 7, one embodiment of a method for laying the carbon nanotube film on a support film is provided. The method can include the following steps of:

S210, providing the carbon nanotube array 110, the support film 120, a protective film 390, a pair of rollers 250 capable of providing a pressure, a first coil 380, a first flattened shaft 382, a second coil 384, and a second flattening shaft 386, wherein the supported film 120 is wound around the first coil 380 to continuously provide the support film 120, the support film 120 is strained through the first flattening shaft 382 and then brought to the roller 250; the protective film 390 is wound around the second coil 384 to continuously provide the protective film 390, the protective film 390 is strained through the second flattening shaft 386 and then brought to the roller 250; the support film 120 and the protective film 390 are passed between the rollers 250;

S220, drawing the original carbon nanotube film 130 from the carbon nanotube array 110, wherein, one end of the original carbon nanotube film 130 is connected with the carbon nanotube array 110, the other end of the original carbon nanotube film 130 is connected with the support film 120 and the protective film 390, the original carbon nanotube film 130 is suspended between the carbon nanotube array 110 and the support film 120 and the protective film 390; the original carbon nanotube film 130 includes a plurality of carbon nanotubes substantially oriented along the first direction X, a width of the original carbon nanotube film 130 is narrower than the width of the support film 120 and the widths of the two roller 250;

S230, soaking the suspended original carbon nanotube film 130 with an atomized organic solvent many times, to form the carbon nanotube film 140, the atomized organic solvent including a plurality of organic droplets 134 with diameters lager than or equal to 10 micrometers, and less than or equal to 100 micrometers; and

S240, stacking the protective film 390, the carbon nanotube film 140 and the support film 120 in order, and then passing between the pair of rollers 250, simultaneously applying the pressure on the stacked protective film 390, carbon nanotube film 140 and support film 120 to combine the carbon nanotube film 140 between the support film 120 and the protective film 390 such that a carbon nanotube composite film structure 300 including the carbon nanotube film 140 fixed between the support film 120 and the protective film 390 is formed.

In step S210, the protective film 390 is configured to protect the carbon nanotube film 140, and includes a protective back film and a release layer coated on the back film. The material of the protective back film can be the same as the material of the support film 120. In one embodiment, the material of the protective back film can be paper or other suitable material. The release layer is in contact with the carbon nanotube film 140 and has a release effect against the carbon nanotube film 140 that enables the carbon nanotube film 140 to be released from the release layer. More specifically, the release layer has a relatively low surface energy. Further, the release layer is combined with the carbon nanotube film 140 by van der Waals attractive force therebetween, and the van der Waals attractive force should be weaker than the attractive force between the carbon nanotube film 140 and the support film 120. Therefore, when releasing the protective film 390 from the surface of the carbon nanotube film 140, the carbon nanotube film 140 will not be released from the support film 120. The release layer can be made of silicon, cross-linkable silicone, paraffin, TEFLON, or any combination thereof. It is to be understood that the protective film 390 can be a release liner of a pressure sensitive adhesive tape.

In step S240, as the rotating of the rollers, the carbon nanotube film 140 is continuously formed, the support film 120 and the protective film 390 are continuously provided, the original carbon nanotube film 130 is continuously drawn form the carbon nanotube array 110 and soaked to form the carbon nanotube film 140, the protective film 390, the carbon nanotube film 140 and the support film 120 are stacked with each other and then passed through the rollers to form the carbon nanotube composite film 300. At the same time, the collecting unit 270 is rotated with the same speed of the rollers 250; the carbon nanotube composite film 300 is continuously collect by the collecting unit 270. The carbon nanotube composite film 300 is continuously produced for a large scale in industry.

Other characteristics of the method for making the carbon nanotube composite film structure 300 are the same as that of the method for making the carbon nanotube composite film 100.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not to restrict the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A method comprising:
providing a carbon nanotube array;
drawing an original carbon nanotube film from the carbon nanotube array, and suspending the original carbon nanotube film to obtain a suspended original carbon nanotube film, the original carbon nanotube film comprising a plurality of carbon nanotubes substantially oriented along a first direction;
soaking the suspended original carbon nanotube film with an atomized organic solvent, to form a carbon nanotube film; and
providing a support film and attaching the carbon nanotube film to the support film,
wherein the atomized organic solvent comprises a plurality of organic droplets separated from each other with diameters of larger than or equal to 10 micrometers, and less than or equal to 100 micrometers.

2. The method of claim 1, wherein the soaking the suspended original carbon nanotube film comprises soaking the suspended original carbon nanotube film with the atomized organic solvent for many times.

3. The method of claim 1, wherein the soaking the suspended original carbon nanotube film comprises:
providing at least one spray nozzle; and
moving the at least one spray nozzle or the suspended original carbon nanotube film along a direction substantially parallel to the first direction, and spraying the plurality of organic droplets from the at least one spray nozzle on the suspended original carbon nanotube film.

4. The method of claim 1, wherein the soaking the suspended original carbon nanotube film comprises:
providing a plurality of spray nozzles spacedly arranged above the original carbon nanotube film along the first direction; and
continuously passing the original carbon nanotube film below the plurality of spray nozzles, and spraying the plurality of organic droplets from the plurality of spray nozzles on the suspended original carbon nanotube film.

5. The method of claim 1, wherein the soaking the suspended original carbon nanotube film comprises:
providing a plurality of spray nozzles arranged along a second direction intercrossed with the first direction; and
moving the plurality of spray nozzles or the suspended original carbon nanotube film along a direction substantially parallel to the first direction, and spraying the plurality of organic droplets from the plurality of spray nozzles on the suspended original carbon nanotube film.

6. The method of claim 1, wherein the atomized organic solvent is made by providing an organic solvent; and atomizing the organic solvent into the plurality of organic droplets.

7. The method of claim 6, wherein the atomizing the organic solvent into the plurality of organic droplets is an ultrasonic atomization method or a high pressure atomizing method.

8. The method of claim 6, wherein the organic solvent is alcohol, methanol, acetone, or acetic acid.

9. The method of claim 1, wherein the attaching the carbon nanotube film to the support film comprises:
overlapping the support film and the carbon nanotube film to obtain a overlapped support and carbon nanotube film; and
hot pressing the overlapped support and carbon nanotube film to fix the carbon nanotube film on the support film.

10. The method of claim 1, wherein the providing the support film and attaching the carbon nanotube film to the support film comprises:
providing the support film and a protective film; and
stacking the protective film, the carbon nanotube film and the support film in that order.

11. A method comprising:
providing a carbon nanotube array, and continuously drawing an original carbon nanotube film from the carbon nanotube array, the original carbon nanotube film comprising a plurality of carbon nanotubes substantially oriented along a first direction, and suspending the original carbon nanotube film to form a suspended original carbon nanotube film;
soaking the suspended original carbon nanotube film with an atomized organic solvent, to form a carbon nanotube film;
continuously supplying a support film from a support film supply unit; and
continuously applying a pressure by a press unit on the carbon nanotube film and the support film to fix the carbon nanotube film on the support film, thereby forming a carbon nanotube composite film structure,
wherein the atomized organic solvent comprises a plurality of organic droplets spaced from each other with diameters of larger than or equal to 10 micrometers, and less than or equal to 100 micrometers.

12. The method of claim 11, wherein the soaking the suspended original carbon nanotube film comprises soaking the suspended original carbon nanotube film with the atomized organic solvent for many times.

13. The method of claim 12, wherein the soaking the suspended original carbon nanotube film comprises:
providing at least one spray nozzle; and
moving the at least one spray nozzle or the suspended original carbon nanotube film along a direction substantially parallel to the first direction, and spraying the plurality of organic droplets from the at least one spray nozzle on the suspended original carbon nanotube film.

14. The method of claim 11, wherein the soaking the suspended original carbon nanotube film comprises:
providing a plurality of spray nozzles arranged above the original carbon nanotube film along the first direction; and
continuously passing the original carbon nanotube film below the plurality of spray nozzles, and spraying the plurality of organic droplets from the plurality of spray nozzles on the suspended original carbon nanotube film.

15. The method of claim 11, wherein the soaking the suspended original carbon nanotube film comprises:
providing a plurality of spray nozzles arranged along a second direction intercrossed with the first direction; and
moving the plurality of spray nozzles or the suspended original carbon nanotube film along a direction substantially parallel to the first direction, and spraying the plurality of organic droplets from the plurality of spray nozzles on the suspended original carbon nanotube film.

16. The method of claim 11, wherein the support film supply unit comprises a coil and the support film wrapped around the coil.

17. The method of claim 16, wherein the step of continuously applying the pressure by the press unit on the carbon nanotube film and the support film to fix the carbon nanotube film on the support film comprises:
providing the press unit capable of generating the pressure and comprising a pair of rollers;
stacking the support film and the carbon nanotube film to form a stacked support and carbon nanotube film; and
passing the stacked support and carbon nanotube film between the pair of rollers, and simultaneously applying the pressure generated from the pair of rollers to the stacked support and carbon nanotube film.

18. The method of claim 17, further comprising a step of providing a collecting unit; and collecting the carbon nanotube composite film structure on the collecting unit.

19. The method of claim 18, further comprising steps of: continuously providing a protective film by a protective film supply unit; and passing the protective film with the stacked support and carbon nanotube film between the pair of rollers to fix the carbon nanotube film between the protective film and the support film.

20. A method comprising:
providing a coil, a support film wrapped around the coil, a carbon nanotube array, and a pair of rollers capable of producing a pressure, and passing one end of the support film between the pair of rollers;
drawing an original carbon nanotube film from the carbon nanotube array, the original carbon nanotube film comprising a plurality of carbon nanotubes substantially oriented along a first direction, suspending the original carbon nanotube film between the carbon nanotube array and the pair of rollers, and connecting one end of the original carbon nanotube film to the support film;
atomizing an organic solvent into a plurality of dispersed organic droplets with diameters of larger than or equal to 10 micrometers, and less than or equal to 100 micrometers, and spraying the plurality of organic droplets from at least one spray nozzle on the suspended original carbon nanotube film to soak the original carbon nanotube film, thereby forming a carbon nanotube film; and
passing the carbon nanotube film and the support film between the pair of rollers and simultaneously applying the pressure generated on the carbon nanotube film and the support film.
